(19) United States
(12) Patent Application Publication
(10) Pub. No.: US 2026/0113620 A1
(43) Pub. Date: Apr. 23, 2026

(54) CUSTOMIZING ALPHA TAGS FOR WIRELESS NETWORK SUBSCRIBERS

(71) Applicant: AT&T Intellectual Property I, L.P., Atlanta, GA (US)

(72) Inventors: Inderpreet Ahluwalia, Austin, TX (US); Jason Sikes, Carnation, WA (US); Jonathan Arze, Chicago, IL (US)

(21) Appl. No.: 18/921,962

(22) Filed: Oct. 21, 2024

(51) Int. Cl. H04W 8/18; G06F 3/0484

(52) U.S. Cl. CPC H04W 8/183; G06F 3/0484

(57) ABSTRACT

A method for customizing alpha tags for wireless network subscribers includes providing a user interface accessible by a user of a subscriber account associated with one or more services of a wireless network operator, receiving, via the user interface, an input from the user indicating a change to an alpha tag displayed on a user endpoint device associated with the subscriber account, and sending a file update to a subscriber identity module of the user endpoint device, where the file update causes an alpha tag displayed on the user endpoint device to be updated in a manner consistent with the change.

The present disclosure relates generally to wireless networks, and relates more particularly to devices, non-transitory computer-readable media, and methods for customizing alpha tags for wireless network subscribers.

### BACKGROUND

An alpha tag is an alphanumeric string that is displayed on the display of a user endpoint device that is connected to a wireless network; typically, the alpha tag identifies the operator of the wireless network. The alpha tag serves several purposes from the network operator perspective, including branding (e.g., to denote and promote the brand of the network operator), denoting that the user endpoint device is receiving service on home and/or partner wireless networks, denoting that the user endpoint device is receiving service on a roaming network (and may incur additional charges for voice and data usage), denoting that a user endpoint device is receiving service according to a particular rate plan (e.g., upgraded Quality of Service), and providing the ability to segment out portions of the wireless network when a user endpoint device is in certain areas of the network (e.g., small cell).

### SUMMARY

In one example, the present disclosure describes a device, computer-readable medium, and method for customizing alpha tags for wireless network subscribers. For instance, in one example, a method performed by a processing system including at least one processor includes providing a user interface accessible by a user of a subscriber account associated with one or more services of a wireless network operator, receiving, via the user interface, an input from the user indicating a change to an alpha tag displayed on a user endpoint device associated with the subscriber account, and sending a file update to a subscriber identity module of the user endpoint device, where the file update causes an alpha tag displayed on the user endpoint device to be updated in a manner consistent with the change.

In another example, a non-transitory computer-readable medium stores instructions which, when executed by the processing system, cause the processing system to perform operations. The operations include providing a user interface accessible by a user of a subscriber account associated with one or more services of a wireless network operator, receiving, via the user interface, an input from the user indicating a change to an alpha tag displayed on a user endpoint device associated with the subscriber account, and sending a file update to a subscriber identity module of the user endpoint device, where the file update causes an alpha tag displayed on the user endpoint device to be updated in a manner consistent with the change.

In another example, a system includes a processing system including at least one processor and a non-transitory computer-readable medium storing instructions which, when executed by the processing system, cause the processing system to perform operations. The operations include providing a user interface accessible by a user of a subscriber account associated with one or more services of a wireless network operator, receiving, via the user interface, an input from the user indicating a change to an alpha tag displayed on a user endpoint device associated with the subscriber account, and sending a file update to a subscriber identity module of the user endpoint device, where the file update causes an alpha tag displayed on the user endpoint device to be updated in a manner consistent with the change.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for customizing alpha tags for wireless network subscribers may operate;

FIG. 2 illustrates a flowchart of an example method for customizing alpha tags for wireless network subscribers; and

FIG. 3 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure provides a system, method, and non-transitory computer readable medium for customizing alpha tags for wireless network subscribers. As discussed above, an alpha tag is an alphanumeric string that is displayed on the display of a user endpoint device that is connected to a wireless network; typically, the alpha tag identifies the operator of the wireless network. The alpha tag serves several purposes from the network operator perspective, including branding (e.g., to denote and promote the brand of the network operator), denoting that the user endpoint device is receiving service on home and/or partner wireless networks, denoting that the user endpoint device is receiving service on a roaming network (and may incur additional charges for voice and data usage), denoting that a user endpoint device is receiving service according to a particular rate plan (e.g., upgraded Quality of Service), and providing the ability to segment out portions of the wireless network when a user endpoint device is in certain areas of the network (e.g., small cell).

The alpha tag is typically identical for all subscribers of the wireless network, e.g., as shown on a startup screen or the very first screen of a smart phone when the smart phone is activated or woken up from a sleep mode. That is, all subscribers of the wireless network (or all subscribers attached to the same part of the wireless network operated by the wireless network operator) will see the same alpha tag displayed on their user endpoint devices (e.g., “AT&T,” “AT&T Microcell,” or the like). Thus, from a subscriber service plan level, all things being equal, there will be no differentiation between one set of subscribers and another set of subscribers, since they will all see the same alpha tag. This is true even for subscribers who may have purchased add-on features. Moreover, subscribers typically do not have any choice in the alpha tag that is displayed to them, i.e., the alpha tag is not subscriber controllable or customizable.

Examples of the present disclosure provide a system that allows a wireless network subscriber to define a customized alpha tag to be displayed on one or more user endpoint devices associated with his or her subscriber account (e.g., a family account, enterprise account, or just multiple different devices used by the same wireless network subscriber). In one example, the system may comprise a web portal or mobile application that the subscriber may log into. Features of the web portal or mobile application may allow the subscriber to define a customized alpha tag for one or more individual users associated with the subscriber's account. The customized alpha tag may comprise an alphanumeric string and/or image (e.g., an emoji, a logo, or the like) chosen by the subscriber that will then be displayed on the displays of the user endpoint devices associated with each of the individual users indicated by the subscriber.

In further examples, customized alpha tags may be defined by the wireless network operator and pushed by the wireless network operator to specific subscribers for temporary display on the subscribers'user endpoint devices (e.g., a “Happy Birthday” message on a subscriber's birthday, holiday greetings such as “Happy Labor Day” or “Happy New Year,” or a message supporting the subscriber's favorite sports team on the day of an important game, e.g., “LET's Go ‘ABC’ Team”).

In further examples still, customized alpha tags may be pushed by the wireless network operator to specific subscribers based on those subscribers'current locations and/or interests. For instance, if a subscriber's user endpoint device is registered in a given city on the same day that the subscriber's favorite sports team or favorite musician is playing in that given city, a customized alpha tag may be pushed to the subscriber's user endpoint device to notify the subscriber of the game or concert. In another example, a customized alpha tag may be pushed to subscribers whose user endpoint devices are detected to be in proximity to (e.g., within some predefined radius of) the location of an emergency situation, such as a traffic accident, a natural disaster, a police activity, or the like.

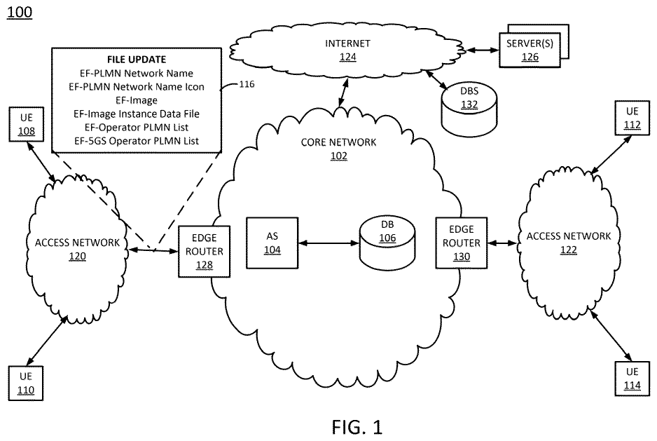

In further examples, the system may track which customized alpha tags were assigned to which individual users under a subscriber account, so that if one of the users changes his or her endpoint device and/or subscriber identity module (SIM) (e.g., as part of an upgrade), any customized alpha tag assigned to that particular user can be carried over to the user's new endpoint device and/or SIM. These and other aspects of the present disclosure are discussed in further detail with reference to FIGS. 1-3, below.

To further aid in understanding the present disclosure, FIG. 1 illustrates an example system 100 in which examples of the present disclosure for customizing alpha tags for wireless network subscribers may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wired network, a wireless network, and/or a cellular network (e.g., 2G-5G, a long term evolution (LTE) network, and the like) related to the current disclosure. It should be noted that an IP network is broadly defined as a network that uses Internet Protocol to exchange data packets. Additional example IP networks include Voice over IP (VoIP) networks, Service over IP (SoIP) networks, the World Wide Web, and the like.

In one example, the system 100 may comprise a core network 102. The core network 102 may be in communication with one or more access networks 120 and 122, and with the Internet 124. In one example, the core network 102 may functionally comprise a fixed mobile convergence (FMC) network, e.g., an IP Multimedia Subsystem (IMS) network. In addition, the core network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. In one example, the core network 102 may include at least one application server (AS) 104, at least one database (DB) 106, and a plurality of edge routers 128-130. For ease of illustration, various additional elements of the core network 102 are omitted from FIG. 1.

In one example, the access networks 120 and 122 may comprise Digital Subscriber Line (DSL) networks, public switched telephone network (PSTN) access networks, broadband cable access networks, Local Area Networks (LANs), wireless access networks (e.g., an IEEE 802.11/Wi-Fi network and the like), cellular access networks, 3^{rd} party networks, and the like. For example, the operator of the core network 102 may provide a cable television service, an IPTV service, or any other types of telecommunication services to subscribers via access networks 120 and 122. In one example, the access networks 120 and 122 may comprise different types of access networks, may comprise the same type of access network, or some access networks may be the same type of access network and other may be different types of access networks. In one example, the core network 102 may be operated by a telecommunication network service provider (e.g., an Internet service provider, or a service provider who provides Internet services in addition to other telecommunication services). The core network 102 and the access networks 120 and 122 may be operated by different service providers, the same service provider or a combination thereof, or the access networks 120 and/or 122 may be operated by entities having core businesses that are not related to telecommunications services, e.g., corporate, governmental, or educational institution LANs, and the like.

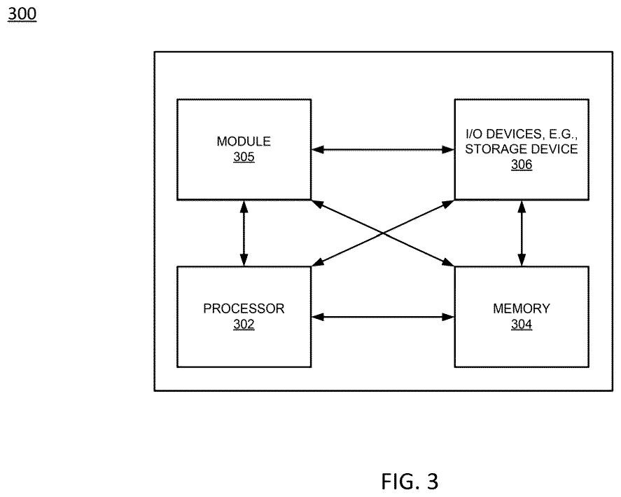

In one example, the access network 120 may be in communication with one or more user endpoint devices 108 and 110. Similarly, the access network 122 may be in communication with one or more user endpoint devices 112 and 114. The access networks 120 and 122 may transmit and receive communications between the user endpoint devices 108, 110, 112, and 114, between the user endpoint devices 108, 110, 112, and 114, the server(s) 126, the AS 104, other components of the core network 102, devices reachable via the Internet in general, and so forth. In one example, each of the user endpoint devices 108, 110, 112, and 114 may comprise any single device or combination of devices that may comprise a user endpoint device, such as computing system 300 depicted in FIG. 3, and may be configured as described below. For example, the user endpoint devices 108, 110, 112, and 114 may each comprise a smart phone, a tablet computer, a laptop computer, a gaming device, a wearable smart device (e.g., a smart watch, a head mounted display, a pair of smart glasses, or the like), an IoT device, a connected vehicle, a bank or cluster of such devices, and the like. In one example, any one of the user endpoint devices 108, 110, 112, and 114 may be operable to run an application that may communicate with the server(s) 126 or other application servers in the system 100, as discussed in greater detail below.

In one example, one or more servers 126 and one or more databases 132 may be accessible to user endpoint devices 108, 110, 112, and 114 via Internet 124 in general. The server(s) 126 and DBs 132 may be associated with Internet software applications that may exchange data with the user endpoint devices 108, 110, 112, and 114 over the Internet 124. In one example, at least some of the servers 126 and DBs 132 host applications that manage review of code changes by generating notifications for delegating code review tasks.

In accordance with the present disclosure, the AS 104 may be configured to provide one or more operations or functions in connection with examples of the present disclosure for customizing alpha tags for wireless network subscribers, as described herein. For instance, in one example, the AS 104 may support a mobile application or a web portal via which a subscriber of a wireless network operator may customize alpha tags for display on one or more user endpoint devices associate with the subscriber's account.

When the AS 104 detects a user input indicating a requested change to an alpha tag associated with a subscriber account, the AS 104 may optionally review the requested change to ensure that, if the alpha tag were to be modified in a manner consistent with the requested change, the resultant modified alpha tag would conform with one or more policies of the wireless network operator. For instance, the one or more policies may limit a number of characters that an alpha tag may contain (e.g., minimum and/or maximum character limit), a nature of the content that the alpha tag may contain (e.g., no obscene or offensive content, no images, etc.), or a number of times that the same subscriber account may customize its alpha tags within a given window of time (e.g., once per week, once per month, once per quarter of a year, etc.). The user input may also identify one or more user endpoint devices or SIMs to which the change to the alpha tag should be applied.

Assuming that the modified alpha tag would conform to the one or more policies of the wireless network operator, the AS 104 may configure and send file updates to one or more files of a SIM for which the alpha tag is to be modified. The file updates may cause the alpha tag displayed on a user endpoint device associated with the SIM to be modified in a manner consistent with the change indicated in the user input. An example file update 116 is illustrated in FIG. 1. The notification may be sent to a UE 108, 110, 112, or 114 identified in the user input.

In one example, at least one of the DBs 106 or 132 may contain subscriber account information. Subscriber account information may include, for a given subscriber account, identities of the user endpoint devices and/or SIMs that are associated with the subscriber account, location histories of the user endpoint devices and/or SIMs, preferences or interests of the users of the user endpoint devices, and data relating to customized alpha tags that are displayed on one or more of the user endpoint devices (e.g., file updates to the SIMs that may cause the customized alpha tags to be displayed in place of a default alpha tag). The subscriber account information may also identify a subscription level or plan associated with the subscriber account and any policies relevant to customization of alpha tags for the subscriber account (e.g., how many times alpha tags associated with the subscriber account have been customized over a given window of time, a limit on the number of times the alpha tags associated with the subscriber account may be customized over a given window of time based on the subscription level or plan (e.g., a higher level plan may allow a greater frequency of requested alpha tag changes), and/or other restrictions on customization of the alpha tags associated with the subscriber account).

The AS 104 may comprise one or more physical devices, e.g., one or more computing systems or servers, such as computing system 300 depicted in FIG. 3, and may be configured as described below. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

In one example, the DB 106 may comprise a physical storage device integrated with the AS 104 (e.g., a database server or a file server), or attached or coupled to the AS 104, in accordance with the present disclosure.

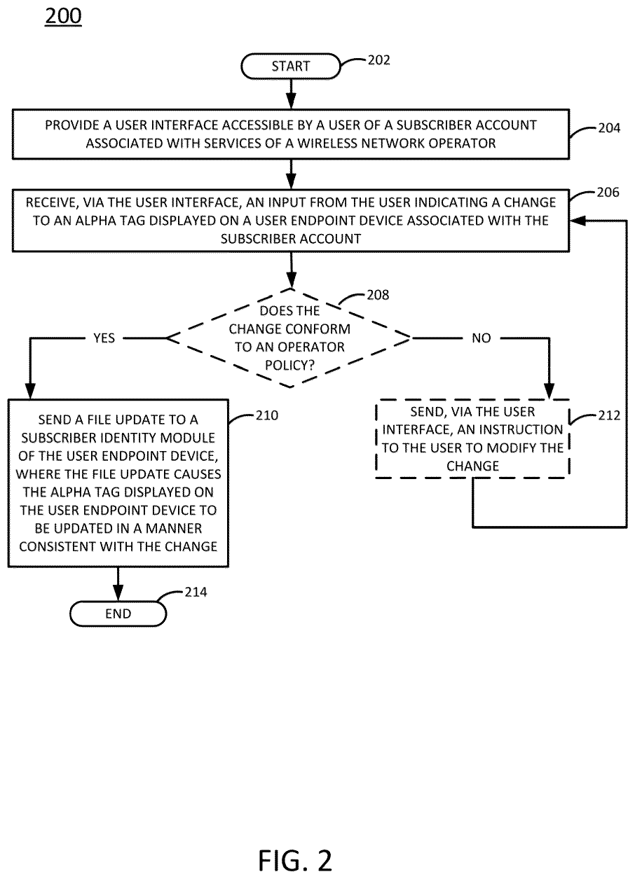

In one example, the AS 104 may load instructions into a memory, or one or more distributed memory units, and execute the instructions for customizing alpha tags for wireless network subscribers, as described herein. For instance, an example method for customizing alpha tags for wireless network subscribers is discussed in further detail below in connection with FIG. 2.

It should be noted that the system 100 has been simplified. Thus, those skilled in the art will realize that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For example, the system 100 may include other network elements (not shown) such as border elements, routers, switches, policy servers, security devices, gateways, a content distribution network (CDN) and the like. For example, portions of the core network 102, access networks 120 and 122, and/or Internet 124 may comprise a content distribution network (CDN) having ingest servers, edge servers, and the like. Similarly, although only two access networks, 120 and 122 are shown, in other examples, access networks 120 and/or 122 may each comprise a plurality of different access networks that may interface with the core network 102 independently or in a chained manner. For example, UE devices 108, 110, 112, and 114 may communicate with the core network 102 via different access networks, user endpoint devices 110 and 112 may communicate with the core network 102 via different access networks, and so forth. Thus, these and other modifications are all contemplated within the scope of the present disclosure.

To further aid in understanding the present disclosure, FIG. 2 illustrates a flowchart of an example method 200 for customizing alpha tags for wireless network subscribers. In one example, the method 200 may be performed by the AS 104 or by another element of the core network 102 illustrated in FIG. 1. However, in other examples, the method 200 may be performed by another device, such as the computing system 300 of FIG. 3, discussed in further detail below. For the sake of discussion, the method 200 is described below as being performed by a processing system (where the processing system may comprise a component of the AS 104 or by another element of the core network 102, the computing system 300, or another device).

The method 200 begins in step 202. In step 204, the processing system may provide a user interface accessible by a user of a subscriber account associated with one or more services of a wireless network operator.

In one example, the user interface may be presented through a mobile application which the user may access on a user endpoint device (e.g., a smart phone, a tablet computer, a laptop computer, a gaming device, a wearable smart device (e.g., a smart watch, a head mounted display, or the like), an IoT device, a connected vehicle, a bank or cluster of such devices, or the like). The user endpoint device may be associated with the subscriber account and may utilize the one or more services of the wireless network operator. In another example, the user interface may be presented through a web portal that the user may log into on a user endpoint device (e.g., a desk top computer, any of the user endpoint devices listed above, or the like). As discussed above, the user is not the wireless network operator.

In one example, the user may be a holder of the subscriber account who manages alpha tags for all lines associated with the subscriber account. In another example, the user may be an individual user of a line associated with the subscriber account (where the subscriber account may be associated with a plurality of different lines used by a plurality of different individual users, such as a family subscriber account with different phone lines for different family members). In another example, the user may be an enterprise manager who manages all employee lines of an enterprise subscriber account. In another example, the user may be the wireless network operator.

In step 206, the processing system may receive, via the user interface, an input from the user indicating a requested change to an alpha tag to be displayed on a user endpoint device associated with the subscriber account.

In one example, a default alpha tag may be displayed on the display of the user endpoint device. For instance, the default alpha tag may identify the wireless network operator. However, according to examples of the present disclosure, the user may be provided with the option to change, via the user interface, the default alpha tag to a customized or personalized alpha tag of the user's choosing to be displayed on his or her own endpoint device. In one example, the change may comprise a modification of the default alpha tag (e.g., so that some elements of the default alpha tag remain) or a replacement of the default alpha tag with a completely new alpha tag. In one example, the ability to customize the alpha tag may be provided to subscribers of the wireless network operator as part of specific service plans.

In one example, the change to the alpha tag may comprise a new alpha tag provided by the user. For instance, the user may formulate a new alpha tag as a sequence of alphanumeric characters and/or images (e.g., emojis, logos, or the like). In another example, the change to the alpha tag may comprise a selection made by the user, where the selection chooses one of a plurality of predefined alpha tags that are provided by the wireless network operator as possible alternatives to the default alpha tag (e.g., these possible alternatives may also be dynamically changeable based on a criterion, e.g., the current location of the subscriber, the current condition surrounding the current location of the subscriber, and the like).

In one example, the input may include an identification of the user endpoint device on which the alpha tag (including the change) is to be displayed. In one example, the user may want the changed alpha tag to be displayed on multiple user endpoint devices, and may include identifications for each of the multiple user endpoint devices. For instance, if the subscriber account is a family account that provides the services of the wireless network operator to a plurality of smart phones and tablets used by parents and one or more children, the user (e.g., one of the parents) may wish to display the changed alpha tag on all of the plurality of smart phones and tablets (the changed alpha tag may, for instance, be a family name or nickname). If the subscriber account is an enterprise account that provides the services of the wireless network operator to a plurality of smart phones and tablets used by employees of an enterprise, the user (e.g., a manager of a group or division of the enterprise) may wish to display the changed alpha tag on a subset of the plurality of smart phones and tablets used by a particular group or division within the enterprise (e.g., research and development, sales, accounting, legal, etc., where the changed alpha tag may, for instance, identify the group or division) or used by employees that hold a specific position within the enterprise (e.g., managers, vice presidents, etc., where the changed alpha tag may, for instance, identify the position) or may present a corporate logo of the enterprise. In another example, the subscriber account may provide the services of the wireless network operator to a plurality of user endpoint devices all used by the same single individual (e.g., a smart phone, a tablet, and a virtual reality headset). In this case, the changed alpha tag may be the single individual's name, gaming or social media handle, or the like.

In optional step 208 (illustrated in phantom), the processing system may determine whether the requested change conforms to a policy of the wireless network operator. In one example, a policy of the wireless network operator may impose certain restrictions on the changes that the user may make to the alpha tag. For instance, in one example, the policy may forbid the change from being implemented if the change would result in the alpha tag exceeding some predefined maximum number of characters (or, conversely, failing to meet at least a predefined minimum number of characters).

In another example, the policy may forbid the change from being implemented if the change would result in the alpha tag including any words, phrase, images, or other content that the wireless network operator does not wish to permit (e.g., obscenities, disparaging sentiments, objectionable images, or the like).

In another example, the policy may forbid the change from being implemented if the change would result in the user exceeding a maximum number of times that he or she is permitted to change the alpha tag within a defined period of time. For instance, different service plans may allow subscribers of the wireless network operator's services to change the alpha tag once a month, three times a month, five times a month, or the like.

In another example, the policy may forbid the change from being implemented if any of the user endpoint devices to which the change is to be applied are incapable of supporting the change. For instance, user endpoint devices of certain types or capabilities may not be capable of displaying anything other than the default alpha tag.

If the processing system concludes in step 208 that the requested change conforms to the policy of the wireless network operator, then the method 200 may proceed to step 210. In step 210, the processing system may send a file update to a subscriber identity module (SIM) of the user endpoint device, where the file update causes an alpha tag displayed on the user endpoint device to be updated in a manner consistent with the change.

In one example, the file update comprises an update to one or more alpha tag files on the SIM of the user endpoint device. For instance, in one example, one or more of the following files on the SIM may be updated: elementary file public land mobile network (EF-PLMN) network name, EL-PLMN network name icon, elementary file (EF) image, or EF-image instance data file, as specified in the Third Generation Partnership Project (3GPP). technical specifications (TS) 31.102.

As defined by 3GPP TS 31.102, EF-PLMN contains the full and short form versions of the network name for a registered PLMN. EF-image instance may contain data for one or more image instances.

In one example, the file update may further include a REFRESH command (using the appropriate REFRESH mode as defined in the 3GPP TS 31.111 and European Telecommunications Standards Institute (ETSI) TS 102 223), which will cause the user endpoint device to re-read the files updated by the file update to update the files in the internal memory and to display the alpha tag on the user endpoint device in a manner consistent with the change.

In one example, the file update may be sent via a SIM over-the-air (OTA) mechanism, such as short messaging service OTA (SMS-OTA) or secure hypertext transfer protocol OTA (HTTPS-OTA).

If, however, the processing system concludes in step 208 that the change does not conform to the policy of the wireless network operator, then the method 200 may proceed to optional step 212. In optional step 212 (illustrated in phantom), the processing system may send, via the user interface, an instruction to the user to modify the requested change that was previously sent by the user.

In one example, the instruction may identify the reason why the change does not conform to the policy of the wireless network operator, so that the user may attempt to modify the change in a manner that better conforms to the policy. For instance, if implementing the change would cause the alpha tag to exceed a predefined maximum number of characters, the instruction may notify the user of the predefined maximum number of characters and request that the user modify the change so that implementing the change will cause the alpha tag to include fewer characters. Similarly, if one or more of the user endpoint devices to which the change is to be applied are incapable of supporting the change, the instruction may identify the user endpoint devices that are incapable of supporting the change and may request that the user modify the change to deselect the identified user endpoint devices. In one example, the processing system may provide a recommended modification to the requested change that would make the requested change better conform with the policy, which the user may accept or ignore.

Once the instruction to modify the change has been sent to the user, the method 200 may return to step 206, and the processing system may proceed as described above to receive a further input from the user indicating a change to the alpha tag.

For instance, once the user has been instructed to modify the change, the user may make modifications to the change so that implementing the change will not cause the alpha tag to violate the policy of the wireless network operator. For instance, the user may reduce a number of characters that the alpha tag would contain as a result of the change, may deselect user endpoint devices that are identified as being incapable of supporting the change, may revise the change to ensure that the alpha tag does not contain any impermissible content, or may make other modifications.

In one example, the processing system may iterate through steps 206-212 as many times as necessary until the input received from the user indicates a change that is consistent with the policy of the wireless network operator. Once the input is determined to indicate a requested change to the alpha tag that conforms to the policy of the wireless network operator, the processing system may proceed to step 210 and send the file update as described above. Once the file update is sent, the method 200 may end in step 214.

Thus, examples of the present disclosure allow a wireless network subscriber to define a customized alpha tag to be displayed on one or more user endpoint devices associated with their subscriber account (e.g., a family account, enterprise account, or just multiple different devices used by the same wireless network subscriber). The customized alpha tag may comprise an alphanumeric string and/or image (e.g., an emoji, a logo, or the like) chosen by the subscriber that will then be displayed on the displays of user endpoint devices associated with each of the user endpoint devices indicated by the subscriber.

Although examples of the disclosure are discussed within the context of subscriber-defined customized alpha tags, it will be appreciated that the wireless network operator may also use similar mechanisms (e.g., SIM OTA file updates) to push operator-defined customized alpha tags to specific subscribers for temporary display on the subscribers'user endpoint devices (e.g., a “Happy Birthday” message on a subscriber's birthday, holiday greetings such as “Happy Labor Day” or “Happy New Year,” or a message supporting the subscriber's favorite sports team on the day of an important game).

In further examples still, customized alpha tags may be pushed by the wireless network operator to specific subscribers based on those subscribers'current locations and/or interests. For instance, if a subscriber's user endpoint device is registered in a given city on the same day that the subscriber's favorite sports team or favorite musician is playing in the given city, a customized alpha tag may be pushed to the subscriber's user endpoint device to notify the subscriber of the game or concert. In another example, a customized alpha tag may be pushed to subscribers whose user endpoint devices are detected to be in proximity to (e.g., within some predefined radius of) the location of an emergency situation, such as a traffic accident, a natural disaster, police activity, or the like.

In the case where customized alpha tags are pushed to subscribers based on the subscribers'locations, additional files may need to be updated in step 210 of the method 200. For instance, at least one of the following files may be updated in addition to the files discussed above in connection with step 210: EF-Operator PLMN List or EF-5GS Operator PLMN List. As defined in 3GPP TS 31.102, EF-Operator PLMN List may contain a prioritized list of location area information (LAI) or tracking area identity (TAI) identities that are used to associate a specific operator name with the LAI/TAI. EF-5GS Operator PLMN List may contain a prioritized list of TAI identities for next-generation (NG)-RAN that are used to associate a specific operator name with the TAI.

In further examples, the system may track which customized alpha tags were assigned to which individual users under a subscriber account, so that if one of the users changes his or her endpoint device and/or subscriber identity module (SIM) (e.g., as part of an upgrade), any customized alpha tag assigned to that particular user can be carried over to the user's new endpoint device and/or SIM.

Although not expressly specified above, one or more steps of the method 200 may include a storing, displaying, and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 that recite a determining operation or involve a decision do not necessarily require that both branches of the determining operation be practiced. In other words, one of the branches of the determining operation can be deemed as an optional step. Furthermore, operations, steps or blocks of the above described method(s) can be combined, separated, and/or performed in a different order from that described above, without departing from the examples of the present disclosure.

FIG. 3 depicts a high-level block diagram of a computing device specifically programmed to perform the functions described herein. For example, any one or more components or devices illustrated in FIG. 1 or described in connection with the method 200 may be implemented as the system 300. For instance, any one or more of the servers 104 or 126 or edge routers 128 or 130 of FIG. 1 (such as might be used to perform the method 200) could be implemented as illustrated in FIG. 3. As depicted in FIG. 3, the system 300 comprises a hardware processor element 302, a memory 304, a module 305 for customizing alpha tags for wireless network subscribers, and various input/output (I/O) devices 306.

The hardware processor 302 may comprise, for example, a microprocessor, a central processing unit (CPU), or the like. The memory 304 may comprise, for example, random access memory (RAM), read only memory (ROM), a disk drive, an optical drive, a magnetic drive, and/or a Universal Serial Bus (USB) drive. The module 305 for customizing alpha tags for wireless network subscribers may include circuitry and/or logic for configuring a user interface to accept inputs for alpha tag customization and for pushing file updates to SIMs to implement customized alpha tags. The input/output devices 306 may include, for example, storage devices (including but not limited to, a tape drive, a floppy drive, a hard disk drive or a compact disk drive), a receiver, a transmitter, a fiber optic communications line, an output port, or a user input device (such as a keyboard, a keypad, a mouse, and the like).

Although only one processor element is shown, it should be noted that the computer may employ a plurality of processor elements. Furthermore, although only one specific-purpose computer is shown in the Figure, if the method(s) as discussed above is implemented in a distributed or parallel manner for a particular illustrative example, i.e., the steps of the above method(s) or the entire method(s) are implemented across multiple or parallel specific-purpose computers, then the specific-purpose computer of this Figure is intended to represent each of those multiple specific-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 305 for customizing alpha tags for wireless network subscribers can be loaded into memory 304 and executed by hardware processor element 302 to implement the steps, functions or operations as discussed above in connection with the example method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 305 for customizing alpha tags for wireless network subscribers (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
providing, by a processing system including at least one processor, a user interface accessible by a user of a subscriber account associated with one or more services of a wireless network operator;
receiving, by the processing system via the user interface, an input from the user indicating a change to an alpha tag displayed on a user endpoint device associated with the subscriber account; and
sending, by the processing system, a file update to a subscriber identity module of the user endpoint device, where the file update causes an alpha tag displayed on the user endpoint device to be updated in a manner consistent with the change.

2. The method of claim 1, wherein the user interface is presented through at least one of: a mobile application or a web portal.

3. The method of claim 1, wherein the change to the alpha tag comprise at least one of: a modification of a default alpha tag or a replacement of the default alpha tag.

4. The method of claim 3, wherein the default alpha tag identifies the wireless network operator.

5. The method of claim 1, wherein the alpha tag comprises a sequence of at least one of: alphanumeric characters or images.

6. The method of claim 1, wherein the change to the alpha tag comprises a new alpha tag that is formulated by the user.

7. The method of claim 1, wherein the change to the alpha tag comprises a selection made by the user, where the selection chooses one of a plurality of predefined alpha tags that are provided by the wireless network operator.

8. The method of claim 1, wherein the input from the user further comprises an identification of the user endpoint device as a user endpoint device on which the alpha tag, as modified according to the change, is to be displayed.

9. The method of claim 8, wherein the user endpoint device is one of a plurality of user endpoint devices on which the alpha tag, as modified according to the change, is to be displayed, and all user endpoint devices of the plurality of user endpoint devices are associated with the subscriber account.

10. The method of claim 9, wherein the subscriber account is one of: an individual account, a family account, or an enterprise account.

11. The method of claim 1, wherein the file update comprises an update on the subscriber identity module to at least one file of: an elementary file public land mobile network network name, an elementary file public land mobile network network name icon, an elementary file image, or an elementary file image instance data file.

12. The method of claim 11, wherein the file update further comprises an update on the subscriber identity module to at least one file of: an elementary file operator public land mobile network list or an elementary file fifth generation operator public land mobile network list.

13. The method of claim 11, wherein the file update further comprises a refresh command that causes the user endpoint device to re-read the at least one file updated by the file update in an internal memory.

14. The method of claim 1, wherein the file update is sent via a subscriber identity module over-the-air mechanism.

15. The method of claim 1, further comprising:
determining, by the processing system prior to the sending, that the change does not conform to a policy of the wireless network operator; and
sending, by the processing system via the user interface, an instruction to the user to modify the change.

16. The method of claim 15, wherein the instruction identifies a reason as to why the change does not conform to the policy of the wireless network operator.

17. The method of claim 15, wherein the policy comprises at least one of: a restriction on a number of characters contained in the alpha tag, a nature of content contained in the alpha tag, or a restriction on a number of times that the user is allowed to change the alpha tag within a defined window of time.

18. The method of claim 15, wherein the policy comprises a restriction on changes to the alpha tag that the user endpoint device is incapable of supporting.

19. A non-transitory computer-readable medium storing instructions which, when executed by a processing system including at least one processor, cause the processing system to perform operations, the operations comprising:
providing a user interface accessible by a user of a subscriber account associated with one or more services of a wireless network operator;
receiving, via the user interface, an input from the user indicating a change to an alpha tag displayed on a user endpoint device associated with the subscriber account; and
sending a file update to a subscriber identity module of the user endpoint device, where the file update causes an alpha tag displayed on the user endpoint device to be updated in a manner consistent with the change.

20. A system comprising:
a processing system including at least one processor; and
a non-transitory computer-readable medium storing instructions which, when executed by the processing system, cause the processing system to perform operations, the operations comprising:
providing a user interface accessible by a user of a subscriber account associated with one or more services of a wireless network operator;
receiving, via the user interface, an input from the user indicating a change to an alpha tag displayed on a user endpoint device associated with the subscriber account; and
sending a file update to a subscriber identity module of the user endpoint device, where the file update causes an alpha tag displayed on the user endpoint device to be updated in a manner consistent with the change.
